(19) United States
(12) Patent Application Publication
(10) Pub. No.: US 2011/0215741 A1
(43) Pub. Date: Sep. 8, 2011

(54) Discharge lamp lighting apparatus and discharge lamp lighting method

(75) Inventor: Shunichi Morimoto, Hyogo (JP)

(73) Assignee: USHIO DENKI KABUSHIKI KAISHA, Tokyo (JP)

(21) Appl. No.: 13/064,131

(22) Filed: Mar. 8, 2011

(30) Foreign Application Priority Data
Mar. 8, 2010 (JP) 2010-0500028

(51) Int. Cl. H01J 29/76

(52) U.S. Cl. 315/395

(57) ABSTRACT

A discharge lamp lighting apparatus and a discharge lamp lighting method, wherein the discharge lamp, that may be lighted in a horizontal arrangement, contains a power source apparatus that lights the discharge lamp, a flex supply unit disposed near the discharge lamp, and a control unit configured to control the flex supply unit. The control unit controls the flex supply unit such that the flex pulls an arc perpendicular to the discharge lamp longitudinal direction at a time of start-up voltage impression. A flux whose density is lower than that at the time of start-up voltage impression is supplied when the discharge lamp reaches a stable state.

### CROSS-REFERENCES TO RELATED APPLICATION

This application claims priority from Japanese Patent Application Serial No. 2010-050028 filed Mar. 8, 2010, the contents of which are incorporated herein by reference in their entirety.

### TECHNICAL FIELD

The present invention relates to a lighting apparatus using a discharge lamp, which is lighted in a horizontal arrangement, and a lighting method thereof, and in particular, to a lighting apparatus using a discharge lamp, which is used in a digital projector as a light source, and a lighting method thereof.

### BACKGROUND

A discharge lamp encloses xenon gas in its discharge space is widely used as a light source for a projector apparatus that projects an image in a theater. In a film projector of a movie screening system in such a theater, a projector projects an image onto a screen by irradiating a 35 mm film with light from a discharge lamp. Currently, however, high performance computer graphics (CG) based digital technology, which provides improved image quality, is available, as digital cinemas are now in widespread use because of the elimination of film deterioration and production costs. Accordingly, in theater movie screening systems, film projectors have been rapidly replaced with digital projectors, which is based on DLP (Digital Light Processing: Registered Trademark) technology.

Thus, the cost and size reduction of the apparatuses is needed. Similarly, reduction for a lamp power source that lights a lamp used in each of the apparatuses is also needed. Under such circumstances, a power source apparatus in a lamp lighting apparatus has been downsized to specifications that satisfy the rated consumption voltage of a target lamp. In such a power source apparatus, an absolute voltage value is lowered by setting maximum attained voltage to a value lower than that in other apparatuses. Further, using a small transformer downsizes of the entire lamp lighting apparatus is devised.

Unfortunately, when such a compact power source apparatus of lower voltage is used to light a lamp, sometimes the lighting results in lamp failure (light-out) due to lighting failure that occurs at time of start-up of the lamp. The lighting failure arises because the compact lamp power source provides a low voltage at time of start-up voltage impression, so that adequate lamp voltage, which is provided by conventional power sources, cannot be supplied to a lamp, whereby an arc cannot be maintained in the lamp.

The lighting failure does not occur in a new discharge lamp having electrodes without wear, but after repetition of lighting, the tip of a cathode becomes worn out, which causes the lighting failure. FIG. 6A illustrates a horizontally arranged discharge lamp such as a xenon lamp 80. When a start-up voltage is impressed to the xenon lamp 80 at time of lighting start-up, dielectric breakdown occurs and a rush current flows between a cathode 84 and an anode 83, so that an arc A is formed between the electrodes. At this point of time, a force, which lifts the arc upward in the vertical direction, is exerted on the arc A due to heat convection and buoyant force of gas, which is enclosed in discharge space of the lamp. In case where usage time of a lamp is short, because the discharge lamp contains a sufficient amount of emitter (electron emissive material) in the cathode 84 and because the cathode 84 has no deformation at the tip and is sufficiently heated by rush current, thermionic emission is soon initiated. During the thermionic emission, electrons from the cathode 84 to the anode 83 flow with momentum within an arc, so that even if there is a force acting on the arc to lift it upward in the vertical direction due to heat convection of gas, the arc itself is not affected by the force.

As time goes by and when the lamp has been used for a certain period of time (e.g., about 1,000 hours), the emitter in the cathode is not supplied in a stable manner. In addition, when the tip portion of the cathode 84 is largely deformed, as illustrated in FIG. 6B, the cathode 84 cannot be sufficiently heated by rush current at time of start-up of lighting. Consequently, thermionic emission cannot be initiated soon, and the flow speed of electrons in the arc from the cathode 84 to the anode 83 decreases. The arc A is largely affected and lifted by the heat convection and buoyant force of gas, so that a bow shaped arc A′ is formed as illustrated in FIG. 6B. As a result, the length of the arc A′ is increased, whereby voltage increases. The resulting lamp voltage exceeds the voltage supplied by the power source, so that the compact power source cannot compensate for the shortage, thereby resulting in lighting failure of the lamp.

As described above, even in a discharge lamp such as a xenon lamp having no flicker problem at time of steady lighting, that is, even in a discharge lamp, which does not reach the end of its life due to flicker and has been used for a short period, wear of a cathode tip may cause lighting failure. If lighting failure occurs, replacement of the discharge lamp with a new one is required before the lamp is completely used. In terms of resources, every lamp is desirably designed so that a life span of the lamp reaches its end before flicker occurs. A power source apparatus of larger size supplying a high lamp voltage at time of start-up voltage impression can solve the above problem. The lighting failure, however, occurs only in 0.3 seconds after start up. The use of a large power source apparatus only for the short period of time limits cost and size reduction of the apparatus, and does not meet user demand.

Japanese Patent Application Publication No. 2003-051286 discloses a discharge lamp apparatus, in which magnets are arranged near a discharge lamp to generate magnetic field acting on a flow of electrons so that any shift of light emitting area due to change in the path of electrons (i.e., arc) can be reduced, the change being caused by time-depending change in shape of electrodes of the discharge lamp. However, in the discharge lamp of this prior art, when the path of electrons (arc) is changed while the lamp is lighted in a stable manner, the change is tried to be corrected, and a magnetic field is generated constantly near the lamp. Thus, it does not provide any solution for lighting failure at time of start-up of a discharge lamp. In addition, the amount of emitter (electron emissive material) enclosed in a cathode decreases after a certain integrated lighting time, so that the amount of emitter supplied to the tip of the cathode becomes unstable. In such a state, when flux is continuously supplied to the arc in the stable lighting, there is a problem that the arc is affected thereby, so that the arc wavers.

### SUMMARY

In view of the above, it is an object to provide a discharge lamp lighting apparatus that includes a discharge lamp that is lighted in a first direction; a power source apparatus that lights the discharge lamp; a flex supply unit disposed near the discharge lamp; and a control unit configured to control the flex supply unit, wherein the control unit controls such that flux is supplied from the flex supply unit in a direction that pulls an arc in a direction perpendicular to the first direction at time of start-up voltage impression, and flux having a density lower than that at time of start-up voltage impression is supplied when the discharge lamp reaches a stable state.

Further, it is an object to provide a discharge lamp lighting method, in which a direct current is supplied to a discharge lamp, which is lighted in a first direction, from a power source apparatus at time of start up of the discharge lamp, the method comprising: supplying flux by a unit to a circumference of the discharge lamp, wherein flux is supplied in a direction in which an arc is pulled in a direction perpendicular to the first direction, and controlling so that flux density is lower than that at time of start-up voltage impression when the discharge lamp reaches a stable state.

### BRIEF DESCRIPTION OF THE DRAWINGS

Other features and advantages of the present discharge lamp lighting apparatus and discharge lamp lighting method will be apparent from the ensuing description, taken in conjunction with the accompanying drawings, in which:

FIG. 1 is a perspective view illustrating a structure of a discharge lamp lighting apparatus according to a first embodiment;

FIG. 2 is a block diagram illustrating a structure of a discharge lamp lighting apparatus;

FIG. 3 illustrates an example of a voltage variation after a start-up voltage is impressed to a discharge lamp;

FIGS. 4A to 4C illustrate operations of a discharge lamp lighting apparatus;

FIG. 5 is a cross sectional plan view illustrating a discharge lamp lighting apparatus according to a second embodiment; and

FIGS. 6A and 6B each illustrate a behavior of arc in a lamp.

### DESCRIPTION

In view of the above, it is an object of the present invention to provide a discharge lamp lighting apparatus and a discharge lamp lighting method, in which any increase in start-up voltage caused by change in an arc due to wear of a cathode used in a discharge lamp can be suppressed, and a high lighting probability can be assured even if a compact power source apparatus is used therein.

To solve the above problem, a discharge lamp lighting apparatus including a discharge lamp that is lighted in first direction (horizontal arrangement), a flex supply unit disposed near the discharge lamp, and a control unit configured to control the flex supply unit. The control unit controls the flex supply unit such that a flux having a density is supplied from the flex supply unit in the direction that pulls an arc in a direction perpendicular to the first direction (downward) at time of start-up voltage impression, and flux having a density lower than the density at time of start-up voltage impression is supplied when the discharge lamp reaches a stable state.

In a discharge lamp lighting method, direct current is supplied to a discharge lamp, which is lighted in a horizontal arrangement, from a power source apparatus at time of start up of the discharge lamp. The method comprises supplying flux by a unit to a circumference of the discharge lamp, wherein flux is supplied in a direction in which an arc is pulled in a downward direction, and controlling so that flux density is lower than that at time of start-up voltage impression when the discharge lamp reaches a stable state.

According to the discharge lamp lighting apparatus and the lighting method, flux is supplied from the flex supply unit such that an arc is pulled downward at time of start-up voltage impression to the discharge lamp, so that the arc, which has been lifted and deformed into a bow shape due to convection in a discharge space of the discharge lamp, drops at the curved middle portion into a straight shape, reducing the discharge distance, and lowering a lamp voltage to be required. Consequently, the discharge lamp can be lighted without lighting failure at time of start-up even if a compact power source apparatus, in which a maximum attained voltage value is set to small, is used therein. After the lighting of the discharge lamp becomes stable, a flux density value is set to be smaller than that at time of start-up voltage impression (including 0), whereby it is possible to maintain a stable lighting state without causing waver of the arc after lighting is started. The present invention, therefore, can provide a discharge lamp lighting apparatus and a lighting method, in which a discharge lamp can be certainly lighted without waver of the arc after lighting is started even when a power source apparatus having a small maximum output voltage is used.

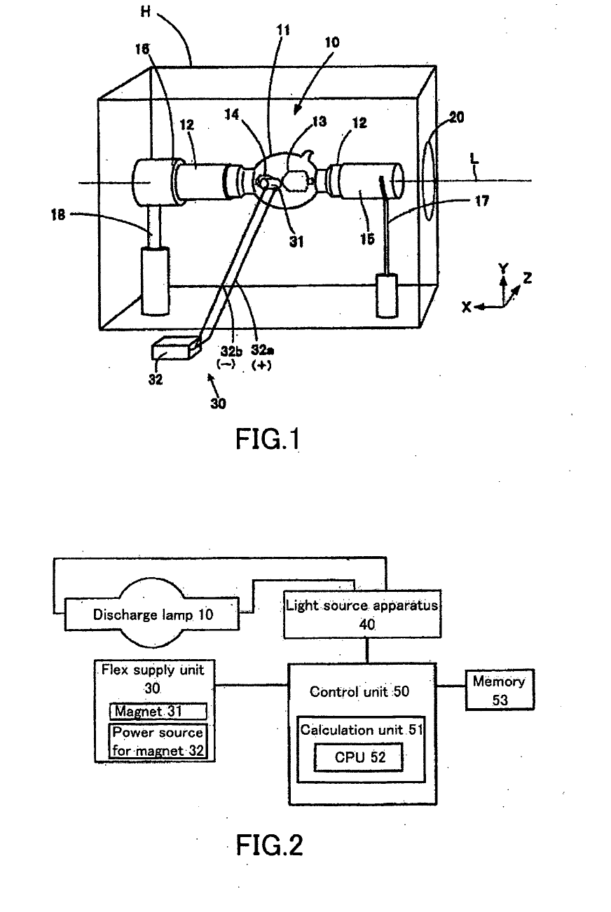

FIG. 1 is a perspective view of a discharge lamp lighting apparatus of a first embodiment. A discharge lamp 10 includes an arc tube 11 that encloses xenon gas at a pressure of, for example, 20 atmospheric pressure. The discharge lamp 10 further includes sealed tubes 12, each of which protrudes from the arc tube 11. The sealed tubes 12 have mouthpieces 15 and 16 at their tips, respectively. The structure is supported by supporting portions 17 and 18 in a lamp housing H such that the tube axis L of the lamp 10 extends approximately in the horizontal direction, wherein each of the supporting portions 17 and 18 has a power supply structure. Although not illustrated, a reflective mirror is arranged to surround a light emission section of the discharge lamp 10 in a circumference of the discharge lamp, so that light emitted from the lamp 10 is collected by the mirror to be emitted through a light projection opening 20 formed in one side face of the lamp housing H. The reflective mirror includes a spheroid face, which usually has a first focal point at the center of arc and a second focal point on the tube axis L.

In the lamp housing H, a rod-shaped electromagnet 31 is provided close to a side face of the arc tube 11 of the discharge lamp 10. Power feeding lines 32a and 32b are respectively connected to one end portion and the other end portion of the electromagnet 31, so that the electromagnet 31 is connected to an electromagnet power source 32. The electromagnet 31 has an axis extending in the horizontal direction, and is supported by a support member (not illustrated) such that an end portion of the electromagnet 31 is directed to a middle point between an anode 13 and a cathode 14. Thus, in the present embodiment, a flex supply unit 30 is made up of the electromagnet 31 and the power source 32.

FIG. 2 is a block view illustrating a structure of a lamp lighting apparatus according. Control of the flex supply unit 30 is described below. The flex supply unit 30 is controlled by a control unit 50 shown in FIG. 2. The control unit 50 basically includes a calculation unit 51 having a central processing unit (CPU) 52 computing timings to drive the flex supply unit 30 based on lamp lighting history information such as integrated lighting time of the discharge lamp 10, lamp input values, the number of lightings, and a memory 53 for storing lighting information of the lamp 10. In the memory 53, in addition to basic operation information including lighting history, lighting hours, input values (electric power, voltage, current), and the number of lightings of the discharge lamp 10, a voltage value right after start-up of the discharge lamp 10 for every star-up of the lamp 10 are stored.

The control unit 50 detects lighting failure risks and determines whether or not a magnetic force supply is necessary, based on the calculation, which uses the voltage value which is stored in the memory 53 and which is obtained immediately after the start-up of the lamp 10. When the control unit 50 determines that supply of magnetic force is necessary, the flex supply unit 30 has the power source 32 supply current to the electromagnet 31, thereby supplying flux to the discharge lamp 10. When the discharge lamp 10 reaches a stable lighting state, the control unit 50 transmits a signal to the flex supply unit 30 to decrease or stop the supply of the current from power source 32 for electromagnet to the electromagnet 31. Accordingly, a flux having a density smaller than that of the flux supplied at time of start-up, is supplied to the discharge lamp 10 in the stable lighting state. In the above description, the “flux having a density smaller than that of the flux supplied at time of start-up” means flex density whose magnitude has substantially no adverse affect on the arc, and may include zero. In other words, there is a case where no flux is supplied. Description will be given in a same manner.

The stable state of the lighting of a discharge lamp can be determined by detecting a voltage value relative to rated voltage of the discharge lamp. A more detail description is provided hereinafter.

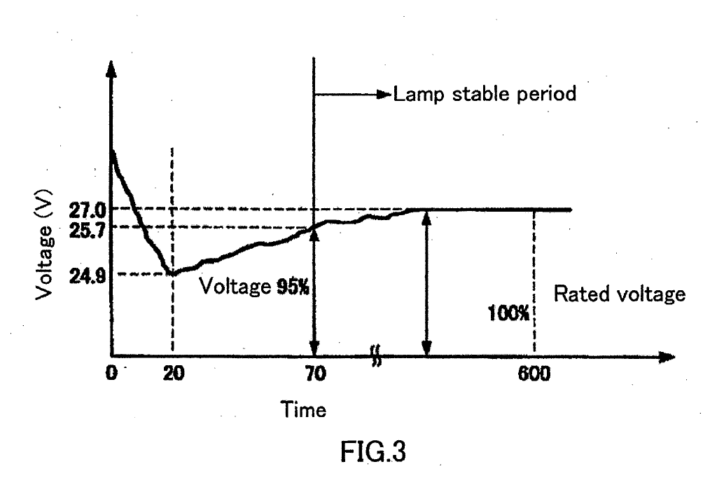

FIG. 3 illustrates a voltage variation, ranging from start-up voltage impression thereto until dielectric breakdown is generated thereby shifting to the rated voltage, in case of the horizontal lighting discharge lamp, of rated power consumption is 2 kW. In the example in FIG. 3, the power source apparatus having a relatively high maximum output voltage is used to light a discharge lamp. In FIG. 3, the dielectric breakdown occurs at time t of 0 sec, and then rush current flows to form an arc between electrodes. For about 10 seconds, a cathode of the lamp is not sufficiently heated so that the arc is in an unstable state. As a result, heat convection and buoyant force of gas makes the arc lifted upward in the vertical direction, thereby forming a bow shape, so that the length of discharge becomes long. Accordingly, although the gas pressure in the lamp is relatively low, a high lamp voltage can be kept at a high level. The electrode is then going to be sufficiently heated, and as the arc is going to reach a stable state, the voltage gradually decreases. When the voltage value reaches the bottom, the temperature of the gas in the lamp starts to rise, and accordingly the voltage starts to rise. As a result, in a few minutes after the dielectric breakdown occurs, the voltage is settled at the rated voltage. When the lamp voltage reaches 95% of the rated voltage, the arc becomes sufficiently stable, and the amount of light emitted from the discharge lamp reaches a range of a sufficient amount of light.

In the present invention, the stable lamp lighting state is detected, a measure is taken to decrease the flex density with respect to the flex supply unit 30. In the case where the stable lighting state of a discharge lamp is detected using lamp voltage, preferably, it can be determined that the lamp is in the stable lighting state if it is at a point of time when the lamp voltage reaches 95% of the rated voltage of the lamp, since the above described relationship can be obtained. More specifically, in the example of FIG. 3 in case of a discharge lamp whose rated power consumption is 2 kW and whose rated voltage is 27 V, the lamp reaches the stable lighting state in about 70 seconds after the start-up, which is time when the lamp voltage is increased to 25.7 V, corresponding to 95% of the rated voltage.

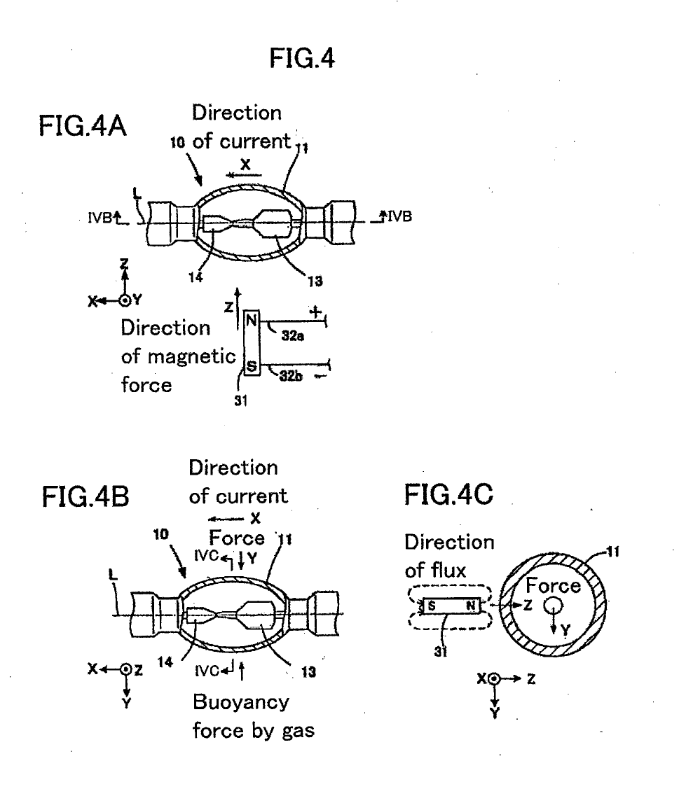

A specific example is given below, referring to FIGS. 4A, 4B, and 4C, as to change in an arc caused by flux supply at time of start-up of a discharge lamp. FIG. 4A is a cross sectional plan view, which is viewed from an upper side of the discharge lamp 10 and the electromagnet 31. FIG. 4B is a cross sectional view, which is viewed from a side of the lamp 10, taken along a line VIB-VIB of FIG. 4A. FIG. 4C is a cross sectional view, taken along the line VIC-VIC of FIG. 4B. In the discharge lamp 10, as the integrated lighting time increases, the tip of the cathode 14 becomes worn out. When the tip of the cathode 14 is deformed and rounded, the heat capacity of the tip portion increases. During a start-up period of the lamp 10 and a period during which electron emission from the tip of the cathode 14 is not enough, the temperature of the tip of the cathode 14 does not rise, and electrons are harder to be emitted, thereby losing stream of an arc. Thus, the arc is easily lifted upward due to convection so that the arc becomes a bow shape and the voltage value increases. At time of start-up voltage impression, as illustrated in FIG. 4A, a magnetic force is supplied from the flex supply unit 30 to the electromagnet 31 such that one end portion of the electromagnet 31 facing the lamp 10 becomes a north pole, and the other end portion becomes a south pole. In other words, in FIG. 4B where a current flows in the X direction, the flux is supplied in the Z direction perpendicular to the plane of the figure, from a front side to a rear side of the plane. As a result, the force acts on the arc A between the cathode 14 and the anode 13 downwardly in the Y direction according to the Fleming's left-hand rule. Accordingly, the arc A, which has been lifted upward due to convection in the discharge space, can be moved downward, so that extension of the length of electric discharge is suppressed, whereby it is possible to suppress a rise of the lamp voltage.

When the arc A reaches a stable state after the discharge lamp 10 is lighted, as described above with reference to FIG. 2, the control unit 50 decreases the amount of supplied flux. As described above, the amount of supplied flux may be zero. The reasons that the amount of supplied flux is decreased, is that since the amount of emitter (electron emissive material) in the cathode 14 decreases after a certain integrated lighting time, and the amount of emitter supplied to the tip of the cathode 14 becomes unstable, if the flux is supplied near the arc tube 11 of the lamp 10, which is in a stable lighting state, the arc becomes more wobble due to the flux. Therefore, the flux that may affect the arc is supplied only at time of start-up of the lamp, and when the lamp reaches the stable state, the density of magnetic flux to be supplied is reduced.

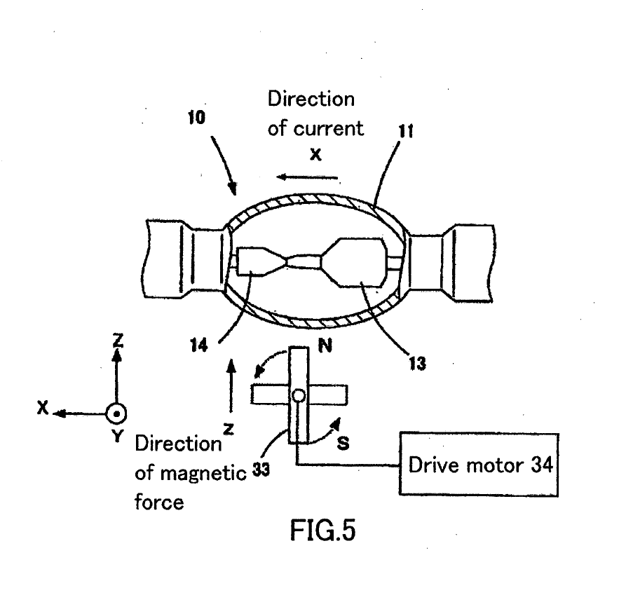

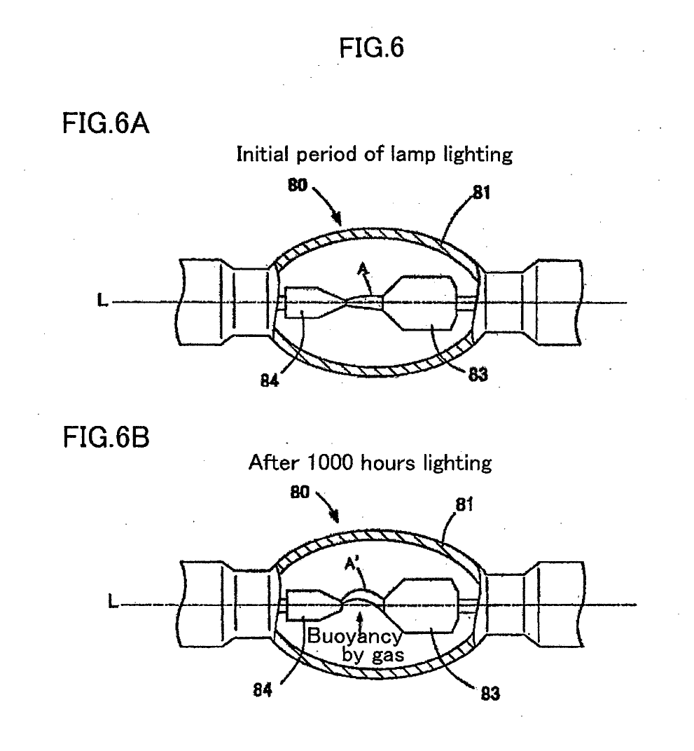

FIG. 5 illustrates a second embodiment of, and is a cross sectional plan view, which is viewed from above of a lamp. In the second embodiment, a magnetic flex supply unit 33, which is made up of a permanent magnet, is used instead of the flex supply unit 30 in the first embodiment. The magnetic flex supply unit 33 is arranged so that a north pole may face a discharge lamp 10 at time of start-up of the discharge lamp 10, thereby supplying flux to an arc tube 11 of the lamp 10. After the lamp 10 reaches a stable lighting state, the magnetic flex supply unit 33 is rotated by 90 degrees by a drive motor 34 connected to the magnetic flex supply unit 33 via a supporting portion (not shown), so that the axis of the magnetic flex supply unit 33 becomes approximately parallel to the tube axis of the lamp 10, so that the supply of flux to the lamp 10 is stopped. The magnetic flex supply unit 33 is driven at timings calculated by the calculation unit 51 of the control unit 50, which is provided in the lamp lighting apparatus illustrated in FIG. 2. Accordingly, orientations of the north and south poles can be controlled such that flux is supplied in the direction that pulls the arc downward (to the vertical rear side of the plane of the FIG. 5).

As described above, a lighting apparatus and a lighting method of a discharge lamp have advantages in that since flux is supplied to the lamp at time of start-up of the lamp, an increase in the lamp voltage at time of start-up, which is generated due to wears of the tip of a cathode with passage of usage time the lamp, can be suppressed, so that the lamp can be lighted without lighting failure even if a compact power source apparatus, in which a maximum attained voltage value is set to small, is used. In addition, after the lamp reaches the stable lighting state, since the density is made small to extent that the supply of the flux does not adversely affect the arc, unnecessary flux is not supplied to the arc while the lamp is in the stable lighting state, so that wobble of the arc is not generated.

The preceding description has been presented only to illustrate and describe exemplary embodiments of the present discharge lamp lighting apparatus and discharge lamp lighting method. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than specifically explained and illustrated without departing from its spirit or scope.

What is claimed is:

1. A discharge lamp lighting apparatus comprising:
a discharge lamp, a flex supply unit, and a control unit;
wherein the control unit controls the flex supply unit to supply a first flex having a first density and to supply a second flex having a second density which is lower than the first density;
the first flex pulls an arc of the discharge lamp in a perpendicular direction that is perpendicular to a longitudinal direction of the discharge lamp at a time of a start-up voltage impression; and
the second flex is supplied when the discharge lamp reaches a stable state.

2. The discharge lamp lighting apparatus according to claim 1, the longitudinal direction of the discharge lamp is a horizontal direction and the perpendicular direction is downward in a vertical direction.

3. The discharge lamp lighting apparatus according to claim 1, the flex supply unit comprising an electromagnet provided close to a side face of the discharge lamp.

4. A discharge lamp lighting method comprising steps of:
supplying a flex by a flex supplying unit to a circumference of the discharge lamp in which an arc is pulled in a perpendicular direction which is perpendicular to a longitudinal direction of the discharge lamp; and
controlling a density of the flux so that the density when the discharge lamp reaches a stable state is lower than the density at a time of start-up voltage impression.

5. The discharge lamp lighting method according to claim 4, the longitudinal direction of the discharge lamp is a horizontal direction and the perpendicular direction is downward in a vertical direction.

6. The discharge lamp lighting method according to claim 4, a direct current is applied to the discharge lamp at the time of start-up voltage impression.
